(19) United States
(12) Patent Application Publication
(10) Pub. No.: US 2011/0286822 A1
(43) Pub. Date: Nov. 24, 2011

(54) AUTOMATED DOCUMENT HANDLING SYSTEM

(75) Inventors: James A. Bradley, Paradise, PA (US); Christopher A. Campbell, West Chester, PA (US); Andrew P. Cook, Springfield, PA (US); Jonathan D. Lewis, Collegeville, PA (US); Gregory H. Selke, Chadds Ford, PA (US)

(73) Assignee: MEI, INC., West Chester, PA (US)

(21) Appl. No.: 13/003,634

(22) PCT Filed: Jul. 10, 2009
(86) PCT No.: PCT/US09/50225

§ 371 Date: Jun. 16, 2011

Related U.S. Application Data
(60) Provisional application No. 61/080,003, filed on Jul. 11, 2008.

(51) Int. Cl. B65G 65/00

(52) U.S. Cl. 414/411; 414/811

(57) ABSTRACT

Automatically processing secure containers housing valuable documents includes receiving a secure container in a secure container processing unit, opening the secure container using an extraction module operatively coupled to the secure container processing unit, removing the valuable documents from the secure container using the extraction module, transferring the valuable documents to an external processing apparatus, and closing the secure container using the extraction module.

### TECHNICAL FIELD

The present disclosure relates generally to a system for handling valuable documents, and more particularly, to an automated system for handling valuable documents contained within a secure lockable container from which valuable documents can be extracted for processing.

### BACKGROUND

In financial institutions or casinos, large volumes of valuable documents (e.g., paper currency, bills, banknotes) are often transported to a central location for counting, sorting and organizing. It is often standard for the transported banknotes to be housed within a secure container to minimize theft or loss. Such secure containers can house various volumes of banknotes depending on the application. Typically secure containers are equipped with a locking mechanism by which only authorized personnel can access and thus retrieve the valuable documents contained therein.

Once the secure container has been transported to a central location within the respective institution, an authorized operator unlocks the secure container to allow access to the valuable documents contained therein. After unlocking the secure container, the operator removes the valuable documents from the secure container and transfers them to a machine for sorting, counting or further organizing. Once the secure container is emptied, the operator may be required (by regulation or law) to demonstrate that the secure container is in fact empty and no valuable documents remain. When such a requirement is present, for instance in a casino cash room, the operator may show a camera on a closed circuit television system that is monitored and recorded in a security room. After the contents of the secure container have been removed and transferred to a sorting machine, the secure container must be re-locked and transported to a secondary station for reuse.

The handling system described above requires at least one operator to physically manipulate the secure containers and the valuable documents contained therein. By having the operator handle the secure container and transfer the contents to a counting machine, the processing speed is limited to the speed at which the operator can perform the described tasks. Also, the security of the valuable documents must be continuously monitored by a secondary security system in order to prevent theft or loss during exposure of the valuable documents. There exists a need to increase the speed at which valuable documents can be extracted and transferred to a counting machine. Additionally, there exists a need to increase the level of security when handling the valuable documents while minimizing the additional expense of having a security system/personnel continuously monitoring the handling process.

### SUMMARY

The present disclosure relates to an automated document handling system. The system can be arranged for transferring valuable documents from a secure container to a sorting machine and for returning the empty secure container for reuse. The secure container is of the type, for example, whereby valuable documents are generally stacked inside a rigid body and the secure container has a lockable access panel. Secure containers are loaded onto a transportation mechanism and sequentially moved to an extraction location. At the extraction location the handling apparatus unlocks the secure container and opens the access panel to expose the valuable documents contained therein. Once the valuable documents contained in the secure container are exposed, the handling apparatus reads an RFID identifier (or any other electronically readable identifier) from the container and sends this information to an external processing unit. The external processing unit associates the contents of the container with a reference card, typically identified by a readable bar-code or other electronically readable label, for tracking (for example). Once an associated reference card has been identified for the specific container, the handling apparatus inserts the reference card at one end of the stacked valuable documents. After the reference card has been inserted onto the stack of valuable documents, the handling apparatus extracts the stack of documents from the container. After the stack of documents has been extracted from the container, the handling apparatus transfers the stack to a sorting machine for processing. The sorting machine can be of various known types and may perform many functions including, but not limited to counting, sorting and authenticating. The stack of valuable papers housed within the secure container may be, but are not limited to paper currency, banknotes or bills.

After the stack of banknotes is transferred from the secure container to the sorting machine by the handling apparatus, the empty container may be required to be shown to a security system to verify the container is empty and no valuable documents remain inside the container. To accomplish this, the handling apparatus can be equipped with a optical recording device to obtain a visual record of the inside of the container, and this information is transferred to an external processing system for recording and storage.

Once the container has been emptied, the handling device closes the access panel of the container and performs a locking operation to ensure the container is locked. After the emptied container has been re-locked, the handling apparatus transfers the empty and secured container to a further transportation mechanism. Empty and secured containers located on the further transportation mechanism can be processed for reuse as required by a given application. The processing for reuse may include, but is not limited to, reading an RFID identifier for each empty secure container and recording any data that may be required to allow the container to be reused.

The foregoing operations can be applied to processing of a single secure container or to a series of secure containers such that a large volume of containers can be processed by the handling apparatus without the need of a human operator. The operations allow for a series of secure containers to be sequentially processed such that the contents of each container can be identified, extracted, processed and recorded as dictated by a specific application.

In one aspect, a system is disclosed for automatically processing secure containers housing valuable documents. The system includes a container processing unit arranged to remove contents of the secure containers, and an extraction module operatively coupled to the container processing unit to open and close the secure containers and to remove the contents of the secure containers.

In another aspect, a method is disclosed for automatically processing secure containers housing valuable documents, the method includes receiving a secure container in a secure container processing unit, opening the secure container using an extraction module operatively coupled to the secure container processing unit, removing the valuable documents from the secure container using the extraction module, transferring the valuable documents to an external processing apparatus, and closing the secure container using the extraction module.

Other aspects, features and advantages will be readily apparent from the detailed description, the accompanying drawings, and the claims.

### BRIEF DESCRIPTION OF THE DRAWINGS

FIG. 1 shows a system for processing secure containers housing valuable documents according to an implementation of the present invention.

FIG. 2 shows an example of a secure container according to the present invention.

FIG. 3 show a secure container with the access panel in an open position according to the present invention.

FIG. 4 shows the secure container housing valuable documents.

FIG. 5 shows the secure container with the access panel removed (to demonstrate an open position) and an example of an extraction module according to the present invention.

FIG. 5A shows the secure container and another example of an extraction module according to the present invention.

FIG. 6A shows an example of a bottom section of an extraction module.

FIG. 6B shows an example of a top section of the extraction module.

FIG. 7A is a side view of the extraction module partially engaged with a stack of documents in a container.

FIG. 7B is a plane view of an example of a pressure plate.

FIG. 8A is a top view of a pressure plate according to an implementation of the present invention.

FIG. 8B is a cross-section of the pressure plate taken along line A-A in FIG. 8A.

### DETAILED DESCRIPTION

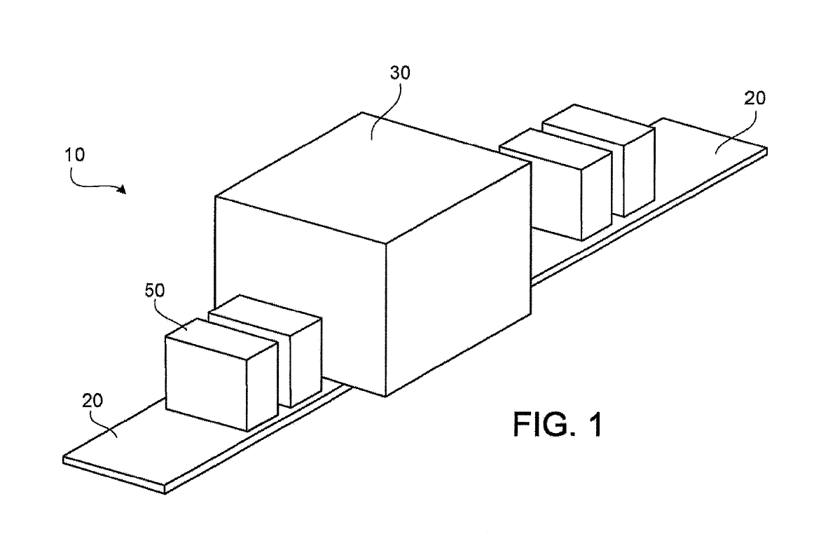

FIG. 1 shows an apparatus 10 for automatically processing secure containers 50. A transportation mechanism 20 transports secure containers 50 to a container processing unit 30, where the contents of the secure containers 50 are extracted for further processing. Details of secure container processing unit 30 are explained in greater detail below. Transportation mechanism 20 can be one continuous mechanism, or two separate mechanisms coupled together by container processing unit 30.

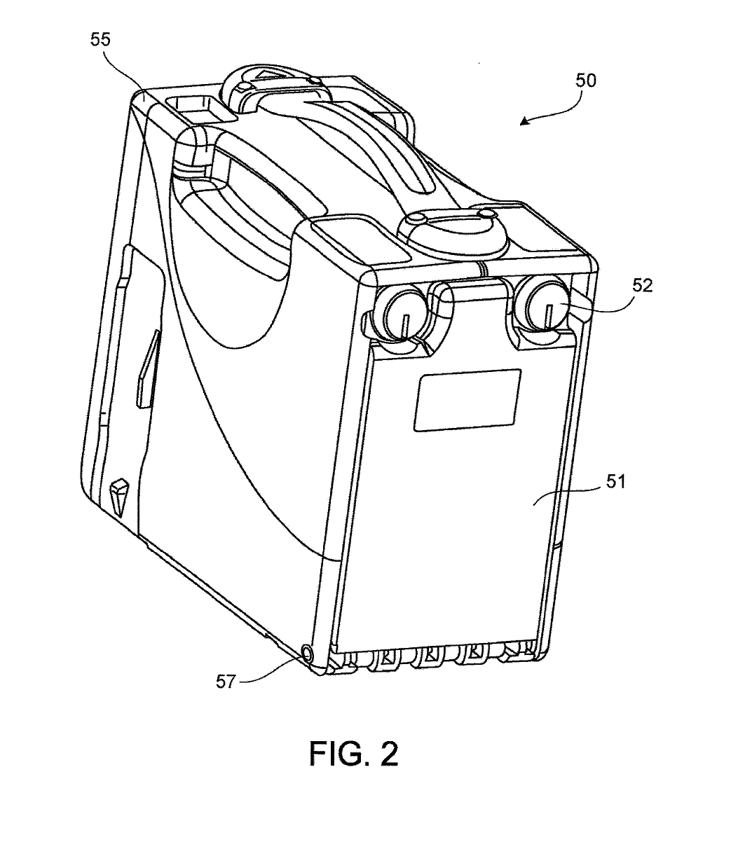

FIG. 2 shows an example of a secure container 50 that includes a housing 55, an access panel 51 and a locking mechanism 52. Access panel 51 is operatively coupled to the container housing 55. In the illustrated example, access panel 51 is pivotally coupled to container housing 55 at pivot 57.

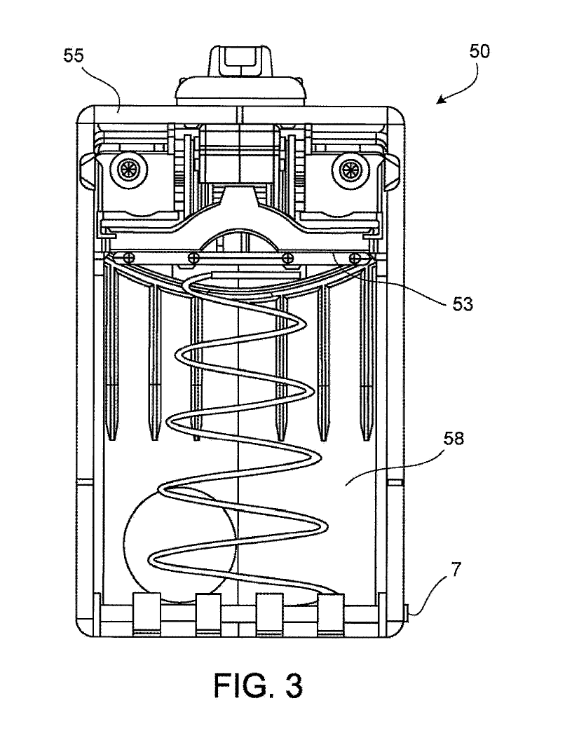

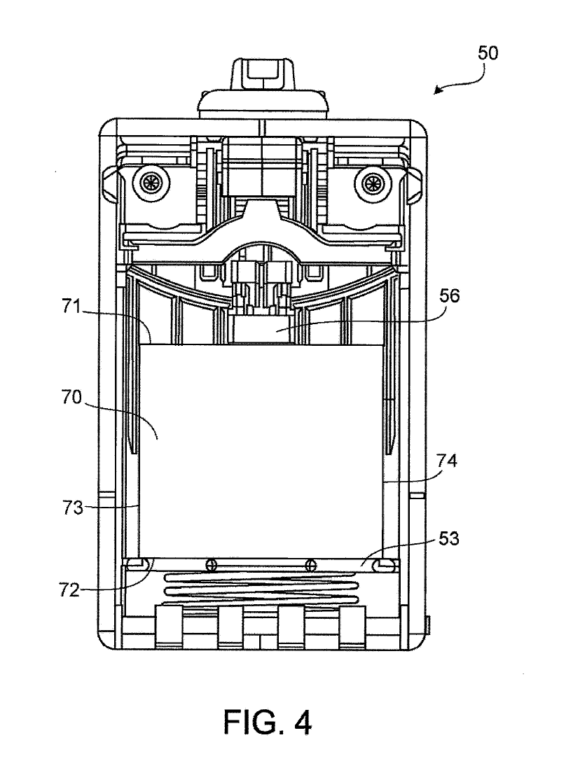

FIG. 3 generally shows secure container 50 with access panel 51 removed (or, for example, in an open condition). Housing 55 of container 50 forms a storage space 58 for housing valuable documents (for example, banknotes) in a storable fashion. In some implementations, secure container 50 stores the valuable documents in a stack. Within storage space 58, a pressure plate 53 is provided for supporting a stack of banknotes within secure container 50. As the size of the stack of banknotes increases, pressure plate 53 is displaced in a downward direction when referring to FIGS. 3 and 4.

FIG. 4 shows secure container 50 with access panel 51 not shown (or, for example, in an open state), thus exposing the contents of storage space 58. In some implementations, a stack of banknotes 70 is housed between a stacking mechanism 56 and pressure plate 53. More specifically, stack 70 abuts stacking mechanism 56 at an upper surface 71 and abuts pressure plate 53 at a lower surface 72. Stack 70 may, in some configurations, be constrained laterally at side surfaces 73 and 74, respectively.

The details of secure container processing unit 30 will now be described. Transportation mechanism 20 sequentially delivers secure containers 50 to secure container processing unit 30 such that one secure container 50 is processed at a time by secure container processing unit 30. The following description refers to the processing of a single container. However, the process is repeated for each secure container 50 that is delivered to secure processing unit 30.

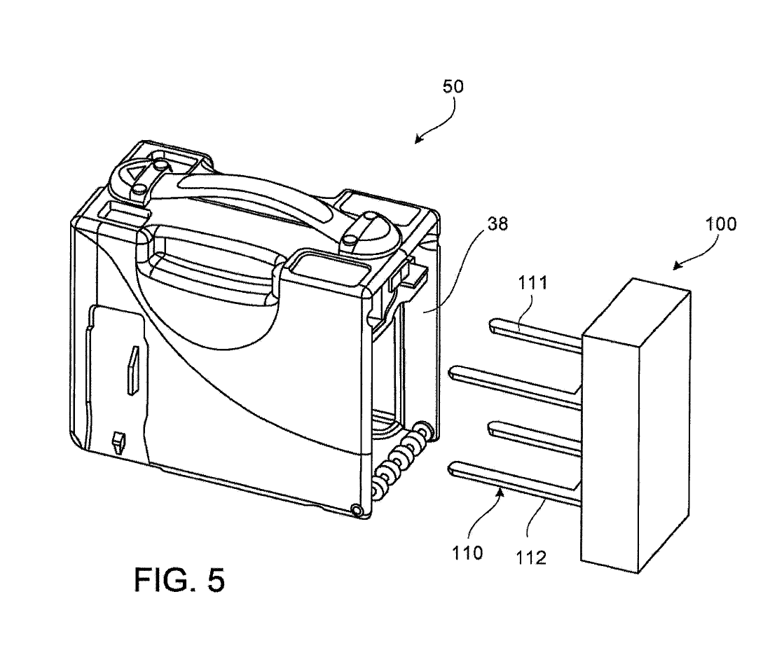

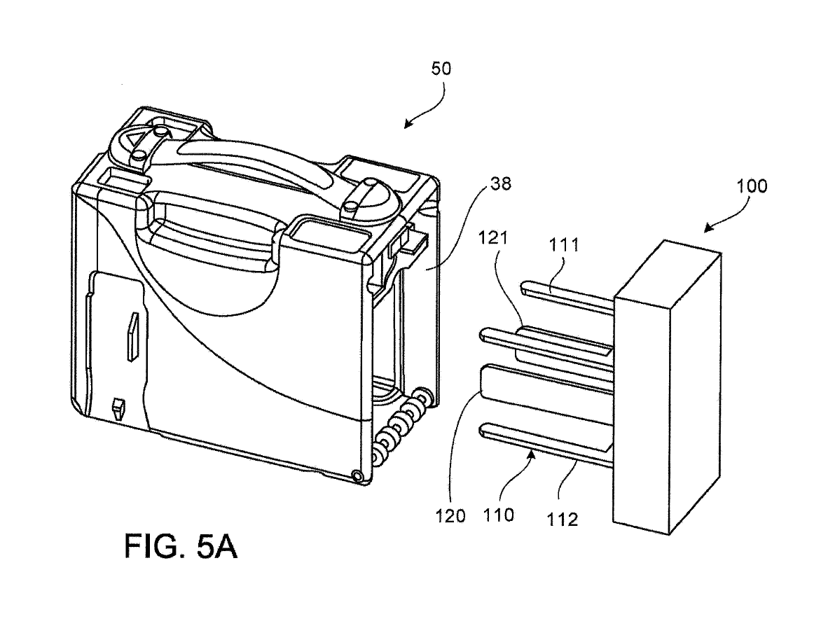

As secure container 50 is delivered to secure container processing unit 30, content extraction module 100 is operable to manipulate secure container 50 and the contents housed therein. Specifically, module 100 includes a lock manipulation tool 120 and a content extraction tool 110. Content extraction tool 110 further includes at least first and second content stabilizers 111 and 112 (FIG. 5), respectively, for handling the contents of said secure container 50 at upper surface 71 and lower surface 72. In some applications, extraction tool 110 further includes a second pair of stabilizers (see FIG. 5A) for handling a stack 70 of banknotes at side surfaces 73 and 74, respectively. Extraction tool 110 is configured to extract a stack 70 of valuable papers from secure container 50 and transfer the stack 70 to an external machine for further processing (for example, counting, sorting or organizing) as commonly known in the art. Extraction module 100 can be operatively coupled to secure container processing unit 30 to allow the transfer of stack 70 from the secure container 50 to an external processing apparatus.

In some configurations, it may be necessary to include a separator card between the contents of sequential secure containers 50. A separator card can include an electronically readable label such that it can be associated to each respective secure container 50 handled by secure container processing unit 30. The separator card can be inserted with the stack of documents prior to extraction from the container or it can be placed between stacks in the sorting machine.

In some implementations, an image of the inside of secure container 50 is recorded once the contents of the container have been removed. For example, there may be regulations or laws that require that a secure container 50 housing valuable documents be verified as empty prior to allowing the container to be re-used. Some implementations include an image recorder operatively coupled to secure container processing unit 30. The image recorder may be that of any number of currently known devices, such as a digital camera or any other known means for recording the image of the inside of secure container 50. While secure container 50 is positioned within secure container processing unit 30, extractor module 100 uses an image recorder to capture an image of the inside of secure container 50 to demonstrate there are no valuable documents remaining. The recorded image of the inside of container 50 is communicated to an external processing device for formal storage. Handling apparatus 10 can be configured to combine an identifier (explained in detail below) for each secure container 50 and the recorded image of the inside (after removal of contents) of container 50 such that an external processing device stores both types of information as a single set of data.

The operation of the system will now be described. First, one or more secure containers 50, each of which has at least one valuable document housed therein, are placed on transportation mechanism 20. Secure containers 50 are sequentially transported by transportation mechanism 20 to secure container processing unit 30. Each secure container 50 is received and handled by secure container processing unit 30. Container processing unit 30 executes various operations, which, in some implementations, are performed at separate stations of within unit 30. To facilitate understanding, the processing of a single secure container 50 is described. However, the same technique can be applied to any number of sequentially supplied secure containers 50. As secure container processing unit 30 receives a secure container 50, extraction module 100 reads the RFID of container 50. The information obtained from the RFID of the secure container 50 is communicated to an external processing apparatus. The reading of an identification of container 50 has been described as occurring prior to opening the container, however this can be done at any point in the processing of a container 50 by secure container processing unit 30.

Once the RFID identifier has been read, lock manipulation tool 120 unlocks secure container 50. Lock manipulation tool 120 is arranged to unlock locking mechanism 52 in a manner commonly know in the art (for example, with a physical or electronic key). If, for example, a physical key is used, the key is inserted into lock 52, which is actuated from the locked position to the unlocked position. In some implementations, access panel 51 is pivotally coupled to housing 55 such that clockwise rotation of the access panel 51 about pivot 57 moves the access panel 51 from a closed position to an open position. Placing access panel 51 in an open position exposes the contents of secure container 50 (a stack 70 of banknotes or other valuable documents) housed in storage space 58. In some implementations, lock manipulation tool 120 is arranged so that when the key is in the unlocked position, lock manipulation tool 120 recognizes that the key cannot be extracted and, in response, lock manipulation tool 120 moves access panel 51 from its closed position to an open position. Once the access panel has been moved to the open position, the key is returned to the locked position and is extracted from the lock. In other implementations the key can remain in the lock without varying in scope from the present disclosure. At this point, container 50 is ready for the next operation, which can be performed either at another station within the container processing unit 30 or by another manipulation tool that removes the contents from the container.

With access panel 51 in an open position, extraction module 100 is moved into position to extract stack 70 of banknotes from storage space 58 of secure container 50. In some implementations, extraction tool 110 extracts stack 70 by operatively engaging the stack 70 with first 111 and second 112 stabilizers. Stabilizers 111 and 112 abut stack 70 at surfaces 71 and 72, respectively. Alternatively, extraction tool 110 can be configured to engage stack 70 with stabilizers 111 and 112 by abutment with surfaces 73 and 74, respectively. Extraction tool 110 can have additional stabilizers as required to properly stabilize stack 70. In some implementations, extraction tool 110 includes a pair of vertically spaced stabilizers 111 and 112 and a pair of horizontally spaced stabilizers 211 and 212. In such a configuration each pair of stabilizers work in conjunction with each other to stabilize stack 70 of container 50.

As shown in FIG. 5, each stabilizer 111, 112 includes fork-like teeth for engaging the stack. In some implementations, container processing unit 30 has an engagement device to engage a gear on the side of container 50 opposite the access door 51 so as to extend the stacker mechanism. This action pushes the stack of documents downward so that the areas of the stack not engaged by the stacker (which is in the middle) are exposed, and top stabilizer 111 can be moved forward so as to abut against the top of the stack. Once top fork 111 is engaged, the stacker mechanism is released, with the result that the top of the stack is constrained by the top fork.

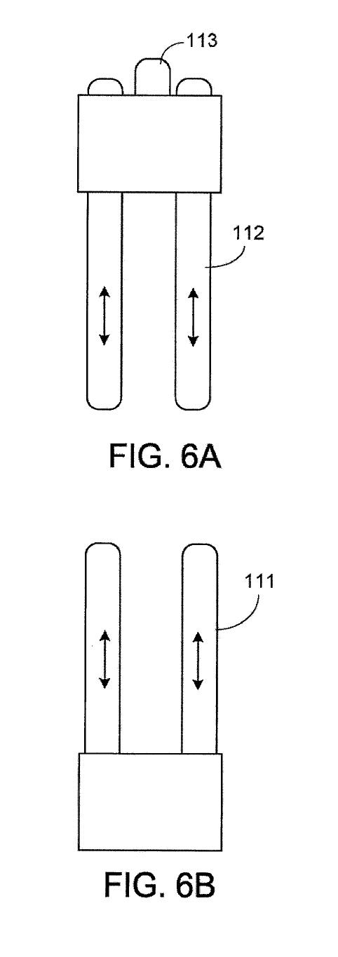

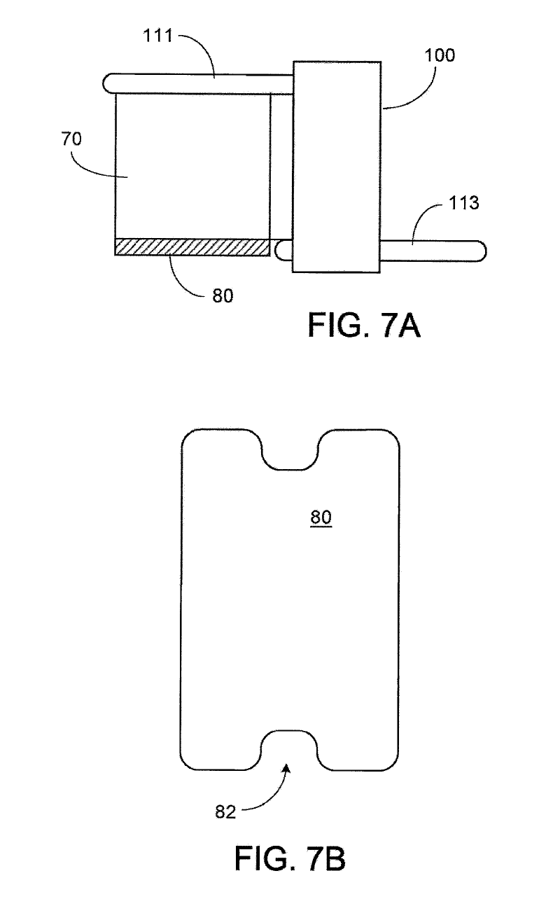

As shown in FIG. 6A, some implementations also include a central stabilizer 113 positioned between the teeth of bottom stabilizer 112. Once top fork 111 is engaged, center stabilizer 113 is moved forward to engage the bottom of stack 70 (see FIG. 7A). This allows for an initial engagement of the stack. As shown in FIG. 7B, a pressure plate 80, which supports the documents in container 50, can include a notch 82 along the end where center stabilizer 113 initially engages the bottom of stack 70 to make it easier for stabilizer 113 to engage the bottom of the stack of documents. Lower fork 112 then is extended to engage the bottom of the stack. In some implementations, upper and lower forks 111, 112 can move vertically in relation to each other so as to apply pressure to the top and bottom of stack 70 and ensure proper stabilization of the stack of documents. The stabilizers can be driven by gears to provide for horizontal and vertical movement. Other forms of actuating the stabilizers are contemplated, for example, by sliding components, rolling components, or rotating components.

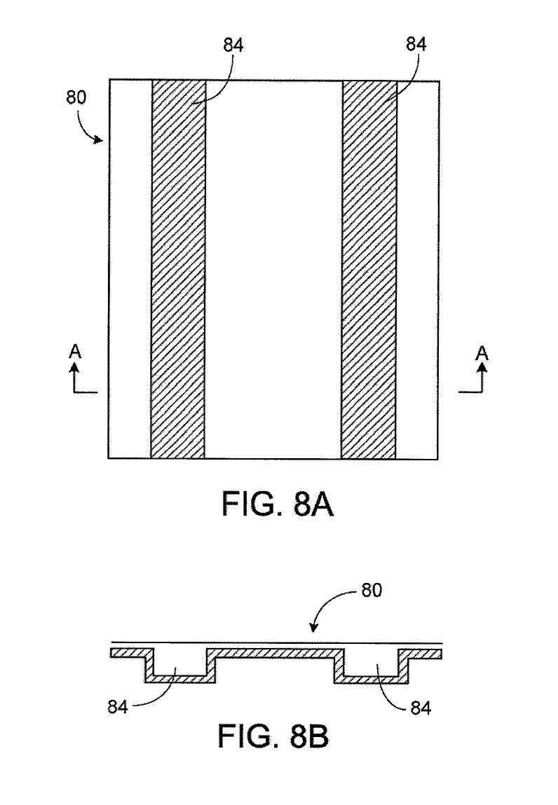

To assist in stabilizing the stack of documents for extraction, some implementations include a modified design for pressure plate 80, as shown in FIG. 8A. In this case, pressure plate 80 has a pair of complimentary recesses (e.g., grooves) 84 aligned substantially parallel to one another to receive the prongs of lower fork 112 so as to allow the lower fork to be inserted under the bottom of the stack 70 more easily. The bottom of stack 70 can be engaged by the lower forks without the need for central stabilizer 113. The top of the stack can be engaged by upper fork 111 as described above.

After extraction tool 110 extracts stack 70 of documents from secure container 50, stack 70 is transferred from secure container processing unit 30 to an external apparatus for additional processing (e.g., counting, sorting and authenticating). Each stack 70 removed from a secure container 50 can be sequentially transferred to the external processing apparatus. In some configurations, secure container processing unit 30 inserts a separator card between each sequentially transferred stack 70. The separator card can be inserted in storage space 58 with stack 70 or it can be inserted between stacks 70 as they are sequentially transferred to the external processing apparatus. Extraction module 100 can be coupled, for example, to a multi-axis robotic arm or other similar motion device to allow movement between the container area and the location of the sorting machine.

In some implementations, it is necessary or desirable to record that secure container 50 is, in fact, empty. After stack 70 is removed from secure container 50, secure container processing unit 30 captures an image of storage space 58 of secure container 50. The image capturing means can be operatively coupled to extraction module 100. Alternatively, the image capturing means can be operatively coupled to secure container processing unit 30. In some implementations, the recorded image of the empty container and the secure container identifier are combined (e.g, the RFID identifier is overlaid onto the image) and the combined information is transferred to an external processing unit (e.g., computer or information processing device) for proper storage and reporting.

After the contents of secure container 50 have been removed (and, in some cases, the empty storage space verified), access panel 51 is returned to a closed position. Once access panel 51 is in the closed position, locking mechanism 52 is actuated from an unlocked state to a locked state. In some implementations, closing access panel 51 and locking lock 52 occurs at a third station within container processing unit 30. The locked secure container 50 then is transported out of, and away from, secure container processing unit 30 by transportation mechanism 20 for further processing. Empty secure containers 50 may have their RFID read by an additional processing station such that they are ready to be reused for storing valuable papers and subsequent processing.

As mentioned above, some implementations of container processing unit 30 include multiple stations, each of which performs a particular operation of set of operations. In any event, containers 50 can be moved through the processing unit continuously, such that each container is processed in a short amount of time (e.g., about 10 seconds).

While specific examples have been described above, various modifications can be made. Therefore, other implementations are within the scope of the claims.

1. A system for automatically processing secure containers housing valuable documents, the system comprising:
a container processing unit arranged to remove contents of the secure containers; and
an extraction module operatively coupled to the container processing unit to open and close the secure containers and to remove the contents of the secure containers.

2. A system according to claim 1 further comprising a transportation mechanism operatively coupled to the container processing unit to transport loaded secure containers to the container processing unit and to transport empty secure containers from the container processing unit.

3. A system according to claim 2 wherein the transportation mechanism comprises first and second transportation mechanisms coupled together by the secure container processing unit.

4. A system according to claim 1 wherein the extraction module further includes an extraction tool operatively coupled to the extraction module to remove the contents of the secure containers.

5. A system according to claim 4 whereby the extraction tool comprises a pair of stabilizers to engage and remove the contents of the secure containers.

6. A system according to claim 5 wherein the stabilizers are vertically spaced from each other.

7. A system according to claim 5 wherein the stabilizers are horizontally spaced from each other.

8. A system according to claim 4 wherein the extraction tool comprises two pairs of stabilizers to engage and remove the contents of the secure containers.

9. A system according to claim 1 wherein the extraction module is arranged to read a respective identifier mounted to the secure container.

10. A system according to claim 9 wherein the identifier includes an electronically readable label.

11. A system according to claim 9 wherein the identifier includes a radio frequency identification device.

12. A system according to claim 1 in any of the preceding claims further including an image recorder to capture an image of the inside of the secure container.

13. A system according to claim 12 wherein the secure container image and the secure container identifier are combined for storage and reporting.

14. A method for automatically processing secure containers housing valuable documents, the method comprising:
receiving a secure container at a secure container processing unit;
opening the secure container using an extraction module operatively coupled to the secure container processing unit;
removing the valuable documents from the secure container using the extraction module;
transferring the valuable documents to an external processing apparatus; and
closing the secure container using the extraction module.

15. A method according to claim 14 further including receiving the secure containers from a transportation mechanism.

16. A method according to claim 14 including using a pair of opposing stabilizers to remove the valuable documents.

17. A method according to claim 14 including transporting the secure containers from the secure container processing unit by the transportation mechanism.

18. A method according to claim 14 including using a first transportation path and a second transportation path operatively coupled at the secure container processing unit.

19. A method according to claim 14 further including reading a respective secure container identifier mounted to each secure container.

20. A method according to claim 19 wherein the identifier includes a radio frequency identification device.

21. A method according to claim 17 wherein the identifier includes an electronically readable label.
